(19) United States
(12) Patent Application Publication
(10) Pub. No.: US 2003/0189297 A1
(43) Pub. Date: Oct. 9, 2003

(54) Sealing device

(76) Inventor: Cheng-Hsiung Chen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/115,089

(22) Filed: Apr. 4, 2002

(51) Int. Cl. F16J 15/32

(52) U.S. Cl. 277/549

(57) ABSTRACT

A sealing device has a protection ring having a first step and a second step formed with the first step. A sleeve ring is received in the protection ring in a water proof manner. The sleeve ring has a first metal ring, a first rubber ring securely bonded to a side of the first metal ring and having a dust proof lip extending out of the first rubber ring to engage with a face of the protection ring to define therebetween a first gap. A sealing ring is received in the protection ring and engaged with the sleeve ring. The sealing ring has a second dust proof lip extending out of the second rubber ring to engage with a face of the second metal ring of the sleeve ring.

### BACKGROUND OF THE INVENTION

1. Field of the Invention

The present invention relates to a sealing device, and more particularly to a sealing device having two gaps respectively defined between a protection ring and a sleeve ring and the sleeve ring and a sealing ring so as to enhance the leakage proof effectiveness especially when an impact from both the axial and radial directions of the sealing device.

2. Description of Related Art

Sealings are widely used in rotation devices involving axle movement to prevent water, dust from entering to damage the axle and above all, to avoid oil leakage to maintain smooth rotation of the axle, which is an essential element to heavy machinery. To accomplish the purpose, various sealing devices are invented. With reference to FIG. 5, a first conventional sealing device is shown and composed of a sleeve ring (50) and a sealing ring (51). The sleeve ring (50) and the sealing ring (51) are not tightly engaged with each other so that when the sealing device is in use, a separation between the sleeve ring (50) and the sealing ring (51) might occur and then damages the bearings and the axle.

With reference to FIG. 6, a second conventional sealing device is shown and composed of a protection ring (60) and a sealing ring (62) securely received in the protection ring (60). The protection ring (60) has a lip (61) extending out of the protection ring (60) so as to function as a prevention of dust and water from entering to damage the axle. A spring (63) is provided on the sealing ring (62). When this type of sealing device is in use with an axle (not shown) and the axle is not aligned with the center of the wheel due to turning, the sealing ring (62) is not able to provide sufficient support to the radial stress. As a consequence, a leakage may occur and thus a damage to the axle is inevitable.

With reference to FIG. 7, a third conventional sealing device, as shown in the U.S. Pat. No. 5/269,536 is shown. The sealing device has a maze-like passage (70), which still allows mud to seep into the passage (70). Furthermore, both sides of the sealing device is provided with rubber (71) so that when the sealing device is under pressure (stress), the sealing device is deformed so that a leakage occurs. Therefore, a damage to the axle is expected.

To overcome the shortcomings, the present invention tends to provide an improved sealing device to mitigate and obviate the aforementioned problems.

### SUMMARY OF THE INVENTION

The primary objective of the present invention is to provide an improved sealing device having two gaps respectively defined between a protection ring and a sleeve ring and the sleeve ring and a sealing ring so as that the leakage effectiveness of the present invention is enhanced in both the radial and axial directions of the sealing device of the present invention.

Another objective of the present invention is that with the arrangement of a first rubber ring, a metal sleeve ring and a second rubber ring, the sealing device of the present invention has excellent leakage prevention effect.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the sealing device of the present invention, wherein a part of the sealing device is cut off so as to have a clear observation to the structure of the invention;

FIG. 2 is an exploded perspective view of the sealing device shown in FIG. 1;

FIG. 3 is a schematic view showing the application of the sealing device used with an axle;

FIG. 4 is a partially enlarged cross sectional view of the sealing device used with the axle;

FIG. 5 is an enlarged cross sectional view of a first conventional sealing device used with an axle;

FIG. 6 is an enlarged cross sectional view of a second conventional sealing device used with an axle; and

FIG. 7 is an enlarged cross sectional view of a third conventional sealing device used with an axle.

### DETAILED DESCRIPTION OF THE PREFERRED EMBODIMENT

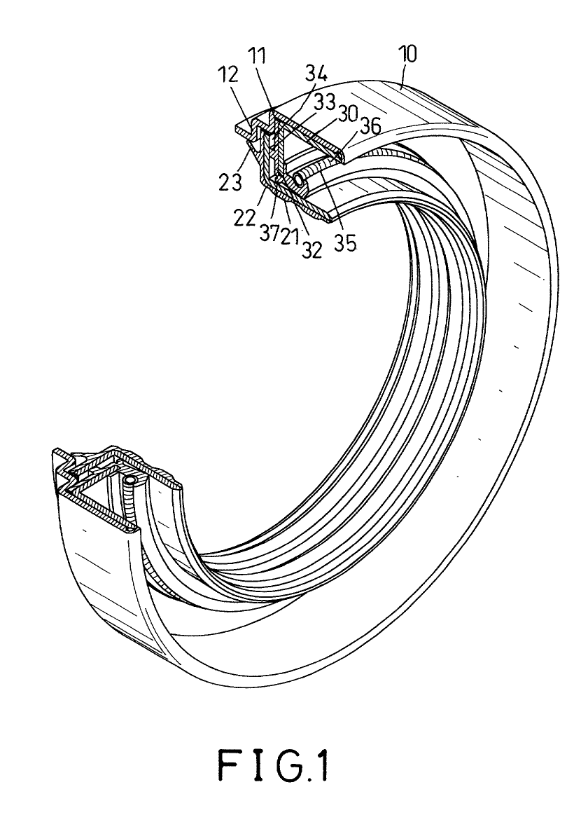

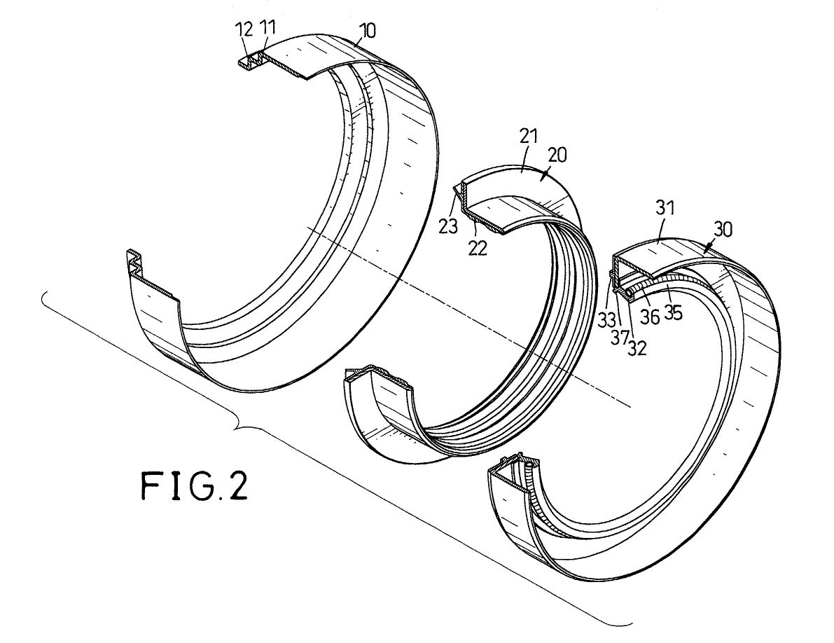

With reference to FIGS. 1 and 2, a sealing device constructed in accordance with the present invention has a protection ring (10), a sleeve ring (20) and a sealing ring (30).

The protection ring (10) has a first step (11) and a second step (12) formed with the first step (11).

The sleeve ring (20) has a first metal ring (21), a first rubber ring (22) securely bonded to one side of the first metal ring (21) and having an L shape in section. The rubber ring (22) further has a first dust proof lip (23) inclinedly formed relative to the rubber ring (22).

The sealing ring (30) has a second metal ring (31), a second rubber ring (32) securely bonded to one side of the second metal ring (31) and having a ledge (33) formed on a face of the second rubber ring (32) to face toward the sleeve ring (20), a recess (35) is defined in a face opposite to the side having the ledge (33) to receive therein a spring (36) and a second dust proof lip (37) formed on the face having the ledge (33) and facing toward the sleeve ring (20).

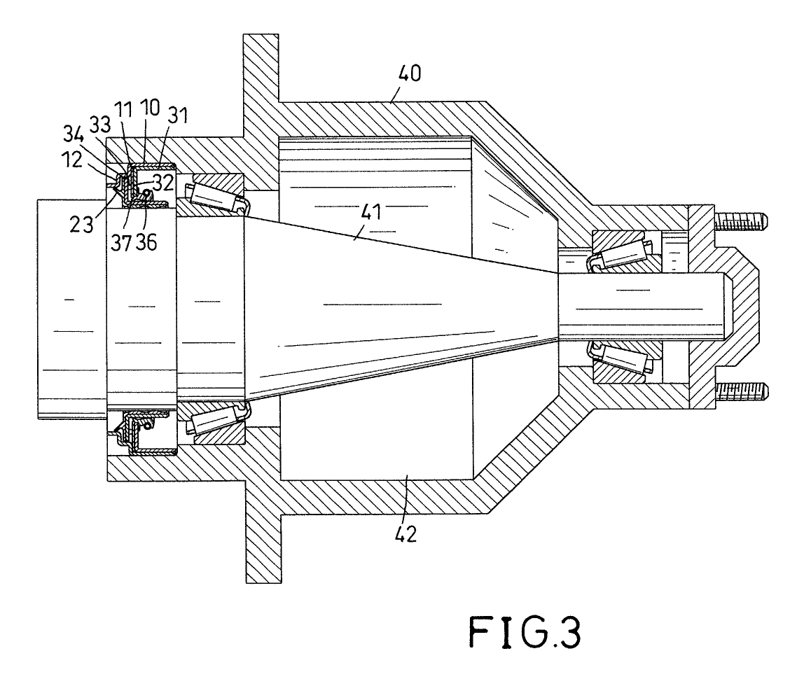

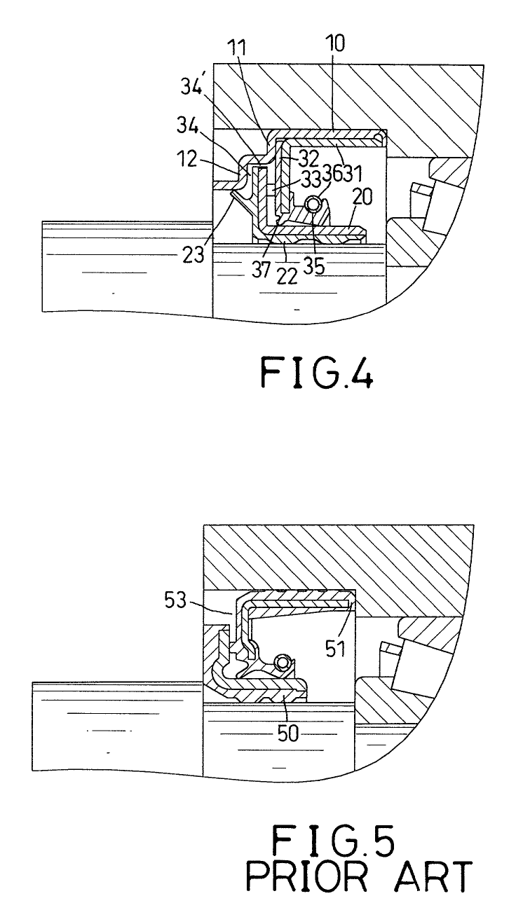

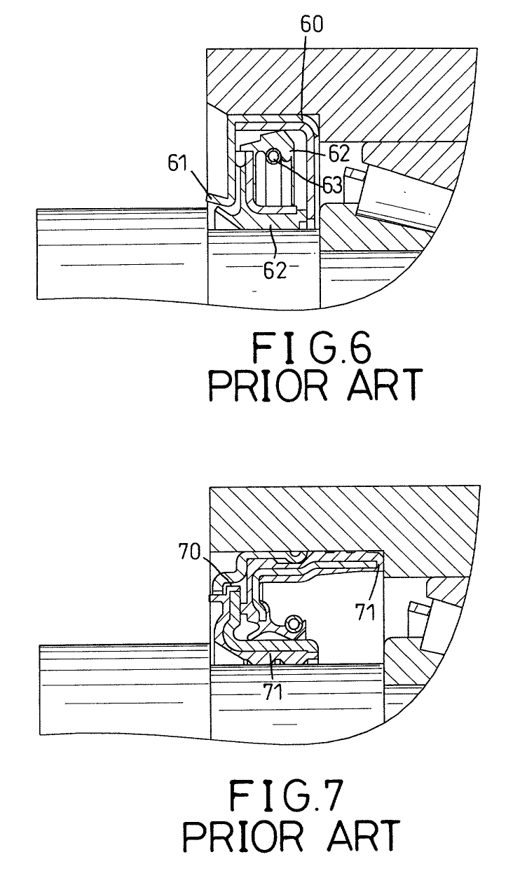

With reference to FIGS. 3 and 4, when the invention is assembled between an axle (41) and a housing (40), it is to be noted that the protection ring (10) receives therein the sleeve ring (20) and the sealing ring (30), wherein the first metal ring (21) engages with a periphery of the protection ring (10) in a water proof manner and the sealing ring (30) also engages with a periphery of the sealing ring (20) in a water proof manner.

The first dust proof lip (23) engages a face of the protection ring (10) to define a first gap (34) therebetween and the ledge (33) engages a face of the metal ring (21) so as to define therebetween a second gap (34′). With the provision of the first and second gaps (34,34′), when the axle (41) experiences a lateral force caused by a turning of the automobile, the first and second gaps (34,34′) are able to function as a shock absorber to both the axial and radial directions with respect to the axle (41). Moreover, the first metal ring (21), the first rubber ring (22), the second metal ring (31) and the second rubber ring (32) together form a hard-soft-hard-soft laminar structure, which is able to fully absorb the shocks. The first dust proof lip (23) and the second dust proof lip (37) also provide a dual dust proof effect to the sealing device of the present invention.

It is then concluded that the present invention has the following advantages:

1. Simple structure: because there are only three elements, the assembly thereof is easy and secured.

2. Better water, dust proof effect: dual dust proof lips (23, 37) ensure that alien material does not seep into the interior of the sealing device so as to damage the axle.

3. Excellent shock absorption: because of the first and the second gaps (34,34′), the sealing device of the present invention is able to enhance the leakage effect in both the axial and radial directions relative to the axle.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sealing device comprising:
a protection ring having a first step and a second step formed with the first step;
a sleeve ring received in the protection ring in a water proof manner, the sleeve ring having a first metal ring, a first rubber ring securely bonded to a side of the first metal ring and having a dust proof lip extending out of the first rubber ring to engage with a face of the protection ring to define therebetween a first gap; and
a sealing ring received in the protection ring and engaged with the sleeve ring, the sealing ring having a second metal ring, a second rubber ring securely bonded to a side of the second metal ring and having a ledge formed on an outer face of the second rubber ring to engage with a face of the first metal ring of the sleeve ring so as to define therebetween a second gap and a second dust proof lip extending out of the second rubber ring to engage with a face of the second metal ring of the sleeve ring,
whereby the first and second gaps function as a shock absorber.

2. The sealing device as claimed in claim 1, wherein the first dust proof lip is inclined with respect to a face of the first rubber ring.

3. The sealing device as claimed in claim 2 further comprising a recess defined in a face opposite to the outer face of the second rubber ring to receive therein a spring.
